(19) United States
(12) Patent Application Publication
(10) Pub. No.: US 2005/0130742 A1
(43) Pub. Date: Jun. 16, 2005

(54) Configurable game controller and method of selectively assigning game functions to controller input devices

(76) Inventors: Philip Feldman, Catonsville, MD (US); Peter Tsai, Olney, MD (US); Greg Merril, Bethesda, MD (US); Jason Grimm, Owings Mills, MD (US); Jeff Schott, Bethesda, MD (US)

Correspondence Address: EDELL, SHAPIRO, FINNAN & LYTLE, LLC, 1901 RESEARCH BOULEVARD, SUITE 400, ROCKVILLE, MD, 20850, US

(21) Appl. No.: 10/975,185

(22) Filed: Oct. 28, 2004

Related U.S. Application Data
(63) Continuation-in-part of application No. 10/806,280, filed on Mar. 23, 2004.
Application No. 10/806,280 is a continuation-in-part of application No. 10/309,565, filed on Dec. 4, 2002.
(60) Provisional application No. 60/514,897, filed on Oct. 29, 2003.

(51) Int. Cl. G06F 17/00; G06F 19/00; A63F 9/24; A63F 13/00; G06K 5/00

(52) U.S. Cl. 463/39; 235/380

(57) ABSTRACT

A configurable game controller according to the present invention selectively assigns functions within a gaming application to controller input devices. The controller includes input devices, signal sources, a switching device and a switch control unit. The input devices are each coupled to a corresponding signal source that detects or measures manipulation of the corresponding input device and produces a signal indicating the measurement. The signals produced by the signal sources are processed by a signal processor whose inputs are associated in a fixed manner with game functions. The switching device receives information from each signal source and provides the appropriate signals to the signal processor inputs to attain the desired configuration or function assignment received from the user via the switch control unit. In addition, the configurable controller may be utilized with an exercise device to enable exercise and/or controller input devices to control gaming functions.

### CROSS-REFERENCE TO RELATED APPLICATIONS

This application is a Continuation-In-Part of U.S. patent application Ser. No. 10/806,280, entitled “Game Controller Support Structure and Isometric Exercise System and Method of Facilitating User Exercise During Game Interaction” and filed Mar. 23, 2004, which is a Continuation-In-Part of U.S. patent application Ser. No. 10/309,565, entitled “Computer Interactive Isometric Exercise System and Method for Operatively Interconnecting the Exercise System to a Computer System for Use as a Peripheral” and filed Dec. 4, 2002. In addition, the present application and aforementioned U.S. patent application Ser. No. 10/806,280 claim priority from U.S. Provisional Patent Application Ser. No. 60/514,897, entitled “Configurable Game Controller and Method of Selectively Assigning Game Functions to Controller Input Devices” and filed Oct. 29, 2003. The disclosures of the above-identified patent applications are incorporated herein by reference in their entireties.

### BACKGROUND OF THE INVENTION

1. Technical Field

The present invention pertains to controllers for entertainment systems. In particular, the present invention pertains to a controller for a video game system, where game functions may be selectively assigned to controller input devices.

2. Discussion of the Related Art

Generally, video game systems employ controllers with multiple joysticks to enable a user to interact with a gaming application. The gaming application includes software that assigns different game functions to each joystick axis. For example, a driving game may have the forward and backward motion of the right joystick simulate the acceleration and deceleration functions of a car, whereas the left and right motion of the left joystick may simulate the functions of the car steering wheel. Although the choices of the software designer for assigning functions to the joystick control are generally acceptable, there may be situations where the choices need improvement. By way of example, a user may be able to use only one hand. With respect to the above-mentioned joystick control functions, this user will have to continually switch between two joysticks in order to control the car movement and speed, thereby making the game much less enjoyable and more difficult for the user to achieve a high performance level.

### OBJECTS AND SUMMARY OF THE INVENTION

Accordingly, it is an object of the present invention to employ a configurable game controller with a gaming system to enable a user to assign functions of a gaming application to desired game controller input devices (e.g., joystick, buttons, mouse, etc.).

Yet another object of the present invention is to employ a configurable game controller with a wide variety of “off the shelf” games or other software programs.

Still another object of the present invention is to employ a configurable game controller with an exercise system to enable selection of exercise device usage and/or manipulation of game controller input devices to control desired functions of a gaming application.

The aforesaid objects are achieved individually and/or in combination, and it is not intended that the present invention be construed as requiring two or more of the objects to be combined unless expressly required by the claims attached hereto.

According to the present invention, a configurable game controller enables a user to assign functions within a gaming application to user-manipulable controller input devices. The controller includes a plurality of input devices, signal sources each associated with an input device, a switching device or matrix and a switch control unit. The input devices are manipulable by a user and are each coupled to a corresponding signal source. The signal source detects or measures manipulation of the corresponding input device and produces a signal indicating the measurement. The signals produced by the signal sources are processed by a signal processor that may be disposed within the controller or be implemented by a gaming system processor. The inputs of the signal processor are associated in a fixed manner with gaming functions, thereby enabling mapping of the input devices or signal sources to those functions. The switching device receives information from each signal source and is coupled to the signal processor inputs. The switch control unit receives configuration information entered by a user and controls the switching device to provide the appropriate signals to the signal processor inputs to attain the desired configuration or function assignment. In addition, the configurable controller may be utilized with an exercise device to selectively enable exercise and/or manipulation of controller input devices to control gaming functions.

The present invention provides several advantages. In particular, the present invention allows for more custom and/or individualized manners of playing games. Further, the enjoyment of playing the game may be increased due to dynamic “blending” or configuring of controller functions. Moreover, the configurable controller of the present invention may reduce repeated use of the same motions in each hand, thereby reducing injuries caused by repetitive motion. In addition, handicapped persons may blend or configure the functions of the controller to minimize the effects of their handicaps while playing games.

The above and still further objects, features and advantages of the present invention will become apparent upon consideration of the following detailed description of specific embodiments thereof, particularly when taken in conjunction with the accompanying drawings wherein like reference numerals in the various figures are utilized to designate like components

### BRIEF DESCRIPTION OF THE DRAWINGS

FIG. 1 is a diagrammatic illustration of a gaming or entertainment system employing configurable controllers according to the present invention.

FIG. 2 is a schematic block diagram of a configurable controller according to the present invention.

FIGS. 3A-3C are perspective views of exercise systems serving as gaming controllers according to the present invention.

FIG. 4 is a schematic block diagram of an exemplary control circuit for the exercise systems of FIGS. 3A-3C.

### DETAILED DESCRIPTION OF THE PREFERRED EMBODIMENTS

A gaming or entertainment system employing controllers according to the present invention is illustrated in FIG. 1. Specifically, the gaming system includes one or more controllers 12, a game processor 14 and a monitor or display 16. The game processor includes a storage drive and/or unit to receive computer readable media (e.g., CD, DVD, etc.) containing software for various games and a processing device to execute the software to provide games on monitor 16. The game processor may be implemented by any conventional or other processor (e.g., microprocessor, personal computer, video gaming processor, etc.). For example, the game processor may be implemented by conventional video games, such as PS2 available from Sony, XBOX available from Microsoft or GAMECUBE available from Nintendo. The monitor is typically implemented by a conventional television or other display. The games generally include characters or objects that are controlled by a user via controllers 12. For example, the user may control movement and actions of a character or a vehicle (e.g., car, airplane, boat, etc.) to move through a virtual environment displayed on monitor 16. The controllers include a plurality of input devices (e.g., joystick, buttons, etc.) to enable a user to interact with the game. The game processor receives signals from the controllers and updates the display to reflect the movements and/or actions of the character or object as indicated by user manipulation of the controller.

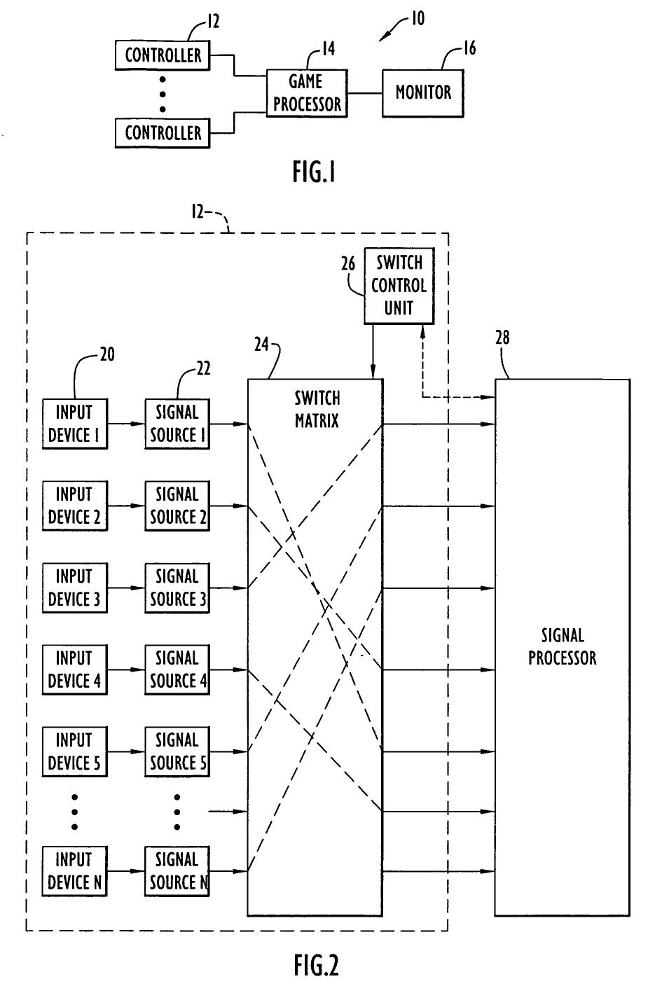

An exemplary controller according to the present invention is illustrated in FIG. 2. Initially, controller 12 may be of the type commonly employed for video games and further includes components to enable assignment of controller input devices to game functions as described below. For example, controller 12 may be of the type used for conventional gaming systems (e.g., PS2, XBOX, GAMECUBE, etc.), such as the type disclosed in U.S. Pat. No. 6,231,444, the disclosure of which is incorporated herein by reference in its entirety. Specifically, controller 12 includes input devices 20, signal sources 22 each associated with an input device, a switching device or matrix 24 and a switch control unit 26. Input devices 20 are each manipulable by a user to enter information or perform some action within a game. These devices may be any conventional or other controller input devices (e.g., button, switch, joystick, etc.).

The input devices are each coupled to one or more corresponding signal sources 22. The signal source basically detects or measures manipulation of the corresponding input device and produces a signal indicating the measurement or detection. The signal source may be implemented by any conventional or other components (e.g., switch, contact, variable resistor or potentiometer, etc.). By way of example only, a controller input device (e.g., joystick, button, trigger, directional pad, etc.) may have each particular axis of motion be associated with a respective signal source in the form of a variable resistor or potentiometer whose resistance varies in accordance with device motion along that axis. The signal source produces a signal indicating a measurement of device motion along the corresponding axis.

The signals produced by signal sources 22 are processed by a signal processor 28. The signal processor may be in the form of game processor 14 (FIG. 1), or a conventional or other processor that arranges the signal information into a format compatible with game processor 14. The inputs of signal processor 28 are conventionally coupled in a fixed manner to specific controller signal sources. Thus, the signal processor or game processor knows the controller input device associated with each input and maps game functions to those inputs (or controller input devices) in accordance with the assignments within the game software.

In order to selectively configure controller 12 for game functions, the controller includes switching device 24 and switch control unit 26. The switching device basically enables information for controller input devices to be selectively placed on signal processor inputs corresponding to the desired game functions. For example, gaming software may assign a car accelerator function to a controller left joystick and maps that function to a particular signal processor input expecting information from the left joystick. However, the switching matrix may couple the signal source of the right joystick to that signal processor input, where the game processor processes the right joystick information for the accelerator function, thereby enabling the right joystick to perform that function. Thus, the controller input devices may be selectively assigned to game functions absent knowledge by the gaming software.

The switching device receives information from each signal source and is coupled to the inputs of signal processor 28. The switching device may be implemented in hardware and/or software by any conventional or other devices capable of switching signals (e.g., switches, multiplexers, processors, cross-bar switches, switching matrix, gate arrays, logic, relays, etc.). The particular switching device embodiment utilized may depend upon the number of controller input devices and level of function assignment or blending desired. For example, in order to exchange functions between joysticks each with motion along an axis (e.g., to swap left-right joystick motion corresponding to a steering function or forward and backward joystick motion corresponding to an accelerator function), two double pole double throw switches may be utilized. The switches basically couple the signal sources of the joysticks (e.g., potentiometers measuring motion along the axis) to the signal processor inputs corresponding to the desired functions. Thus, the functions of each joystick may be performed by the other (e.g., swapped) or one joystick may perform both functions (e.g., steering and accelerator) in accordance with the connections. Applications of higher complexity with respect to blending functions may require additional selector switches and various combinations of selector switch settings.

The switching device may be implemented by devices that can switch signals in the analog or digital domain. For example, the switching device may be implemented by a processor or router that receives signals from the signal sources and directs the signals to the signal processor inputs corresponding to the desired functions. These tasks may be accomplished in software. The switching device switches signals in accordance with controls from a switch control unit 26. The switch control unit may include one or more controls disposed on controller 12, where the controls are manipulable by a user to configure the switching device directly. Alternatively, the switch control unit may include a control processor to control the switching device in accordance with the controls to achieve the desired function assignment. The controls may be implemented by any conventional or other input devices (e.g., buttons, keys, slides, etc.) to provide control signals to the switching device or control processor.

The switching device or switch control unit may alternatively provide a user interface to enable the user to enter information to configure the controller in the desired manner. The interface may be in the form of screens on a controller display or controller lights or other indicators. Further, the interface may be shown on display 16 and implemented by game processor 14. The switch control unit receives the configuration information entered by a user and controls switching device 24 to provide the appropriate signals to signal processor 28 to attain the desired configuration or function assignment.

Operation of the present invention controller is described with reference to FIGS. 1-2. Initially, a user places a storage medium containing gaming software in game processor 14 to commence a gaming session. The user determines the controller input devices desired for the particular game functions and manipulates controls on controller 12 for the desired configuration. Switch control unit 26 controls switching device 24 to establish connections between the appropriate controller input devices and signal processor inputs corresponding to the desired functions as described above in order to achieve the desired function assignment. During the gaming session, the user manipulates the controller input devices, where the game processor receives signals for the gaming functions from the respective controller input devices as prescribed by the user and processes the signals to update the display in accordance with that user manipulation.

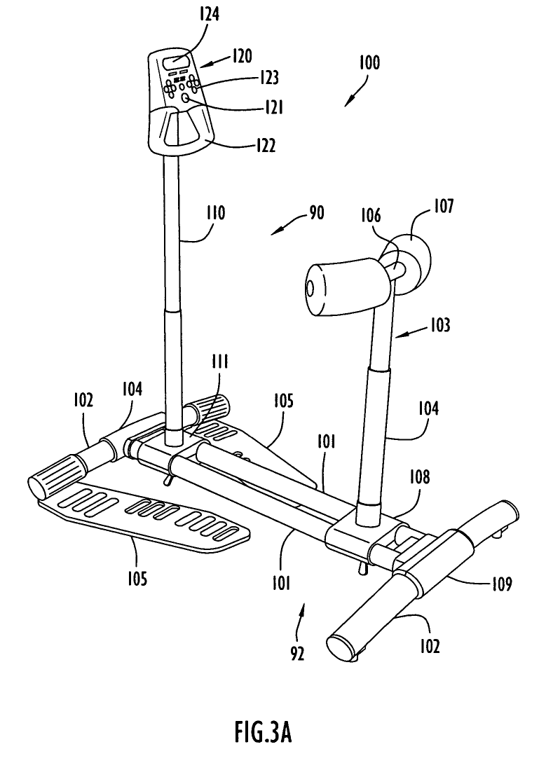

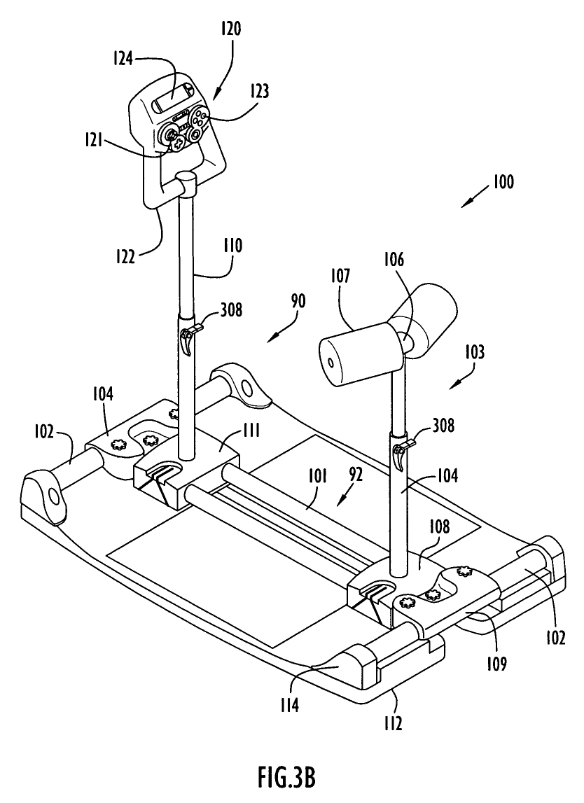

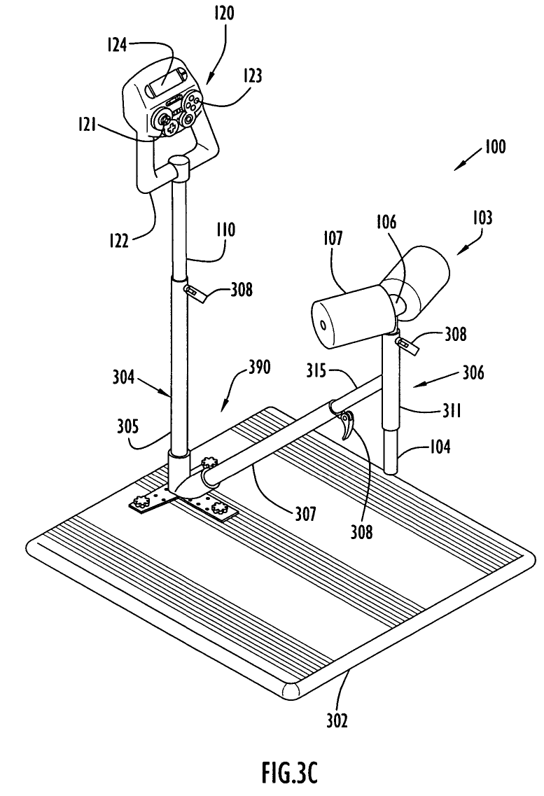

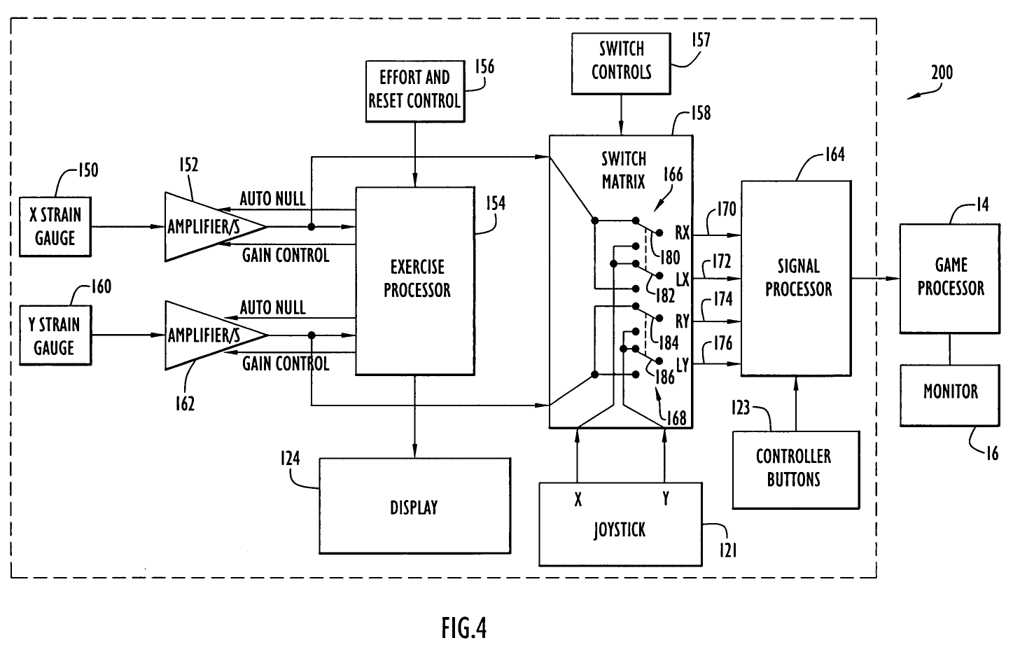

The present invention may be utilized in various applications. In particular, the present invention may be employed within an exercise device used as a peripheral to a gaming system as illustrated in FIGS. 3A-3C. Initially, the exercise system may be of the type disclosed in U.S. patent application Ser. No. 10/309,565, entitled “Computer Interactive Isometric Exercise System and Method for Operatively Interconnecting the Exercise System to a Computer System for Use as a Peripheral” and filed Dec. 4, 2002, the disclosure of which is incorporated herein by reference in its entirety. The exercise system basically serves as a controller to provide user information to game processor 14 (FIG. 1) and enable the user to interact with the game in accordance with exercise performed by the user on the system as described below.

Referring to FIG. 3A, system 100 includes a frame 90 with a base 92 including elongated first base members 101 and elongated second base members 102. The second base members are each attached at a corresponding end of the first base members via brackets or clamps 109 to form an “I” configuration for the base. The first base members basically extend substantially in parallel between the second base members and are separated by a slight distance.

The second base members engage a support surface and include a slight curved configuration to suspend the first base members slightly above that surface. The second base member at the front of the system includes grips 105 disposed at each end and extending rearward therefrom to provide a gripping surface for user feet and to stabilize the system frame. A support 103 configured to support a user lower body portion (e.g., buttocks) is secured to a rear portion of the first base members via a bracket or clamp 108. Support 103 includes a substantially upright post 104 and a support member 106 attached to the top of the upright post to form a “T” type configuration. The support member includes a curved configuration to contour a user body portion and pads 107 extending inward from each support member end to enhance user comfort.

The frame further includes an effector bar 110 for manipulation by a user. In particular, effector bar 110 is attached, via a bracket or clamp 111, to first base members 101 proximate front second base member 102. The effector bar is substantially upright and preferably modular and is constructed of a suitably rigid material (e.g., a metal alloy) that is capable of being slightly deflected within its elastic limit in response to any combination of bending, twisting, tension and compression forces applied by the user to the bar. While the effector bar is generally cylindrical, it is noted that the effector bar may be of any suitable shape (e.g., bent or curved, V-shaped, etc.) and have any suitable exterior surface geometries (e.g., curved, multifaceted, etc.). Additional effector bars may be secured to effector bar 110 to provide various configurations for exercise, while extender rods and/or lock mechanisms may be employed to adjust the effector bar and/or support in accordance with user characteristics (e.g., height, reach, etc.).

A controller 120 is attached or secured to the effector bar upper portion. The controller may be of the type available for conventional video games (e.g., PS2 available from Sony, XBOX from Microsoft, GAMECUBE available from Nintendo, etc.), such as the device described in aforementioned U.S. Pat. No. 6,231,444, and is similar to controller 12 described above. The controller preferably includes a series of buttons 123 and a joystick 121 disposed on the controller upper portion. The joystick and effector bar may be selectively configured or assigned to game functions as described below. Basically, effector bar 110 serves the function of a second controller joystick with respect to a game. The controller generally includes respective signal sources (e.g., variable resistor or potentiometers) to provide signals indicating joystick motion along X (e.g., left/right motions) and Y (e.g., forward/back motions) axes. However, the controller may include any quantity of any type of input devices (e.g., buttons, switches, a keypad, joystick, etc.) and signal sources disposed at any location and arranged in any fashion on the controller. The buttons and joystick may be utilized to enter any desired information (e.g., enter desired user actions for the game, etc.). Further, the controller may include input devices 156 (FIG. 4) to enter and reset resistance controls and reset clock or other functions, and input devices 157 to control function assignment of controller input devices as described below. Devices 156, 157 may be implemented by any conventional or other input devices (e.g., buttons, slides, switches, etc.). The controller lower portion includes a generally “U”-shaped handle or grip 122 for engagement by a user.

Effector bar 110 includes at least one sensor to measure at least one type of strain applied by the user to that bar. Preferably, effector bar 110 includes strain gauge sensors 150, 160 (FIG. 4) that are arranged at suitable locations on the bar near the controller. These sensors measure the amount of a strain deformation applied to the bar as a result of the user applying pushing, pulling or lateral forces to the controller handle. By way of example only, sensor 150 may measure force applied to the effector bar along an X-axis (e.g., lateral or left/right forces), while sensor 160 may measure forces applied to the effector bar along a Y-axis (e.g., push/pull or forward/backward forces). Additional effector bars may each include respective strain gauge sensors to measure the amounts of bending strain applied to those bars.

The sensors are connected to a control circuit 200 (FIG. 4) within controller 120 via appropriate wiring, where the controller provides appropriate information to game processor 14. Strain gauge measurements that are received by game processor 14 are processed to display a video game scenario on display 16. The scenario is updated in accordance with strain forces applied to the effector bar by a user. The controller may further be configured to control the level of exertion required by a user for one or more effectors in order to achieve a particular response in the video game scenario. Resistance levels may be input to an exercise processor 154 (FIG. 4) by the user via input devices 156 (e.g., a keypad). Alternatively, or in combination with user input, the resistance levels may be controlled by the exercise processor based upon conditions within the video game scenario, such as changing wind conditions, changing grade of the terrain (e.g., going uphill), etc.

A display 124 is further disposed on the controller upper portion and may display various information to the user (e.g., the degree of force applied to a particular effector bar at any given time, the amount of work performed by the user during a particular exercise session, resistance levels, time or elapsed time, force applied to the various axes (X and Y axes), instantaneous force applied and/or any other exercise or other related information). The display is preferably implemented by a Liquid Crystal Display (LCD), but may be any type of display (e.g., LED, etc.).

An alternative exercise system employing a configurable controller is illustrated in FIG. 3B. Exercise system 100 is substantially similar to the exercise system described above for FIG. 3A, with base 92 secured to a platform 112 to provide a gripping surface for user feet. The platform is substantially rectangular and includes a gripping surface (e.g., rubber or rubber type material, etc.) for user feet and receptacles 114 each disposed toward a corresponding platform corner. The receptacles each engage a corresponding end of a second base member 102 to secure the frame to the platform. Lock mechanisms 308 enable adjustment of effector bar and support height. Controller 120 is substantially similar to the controller described above and includes a slightly modified arrangement of input devices (e.g., joystick 121, buttons, 123, etc.). Controller handle 122 is mounted to the top surface of effector bar 110 to enable user interaction with a video game.

Yet another exercise system is illustrated in FIG. 3C. System 100 is similar to the exercise systems described above and includes a frame 390 mounted to a base platform 302. The base platform is substantially rectangular and includes a gripping surface (e.g., rubber or rubber type material, etc.) for user feet. Frame 390 includes a generally ‘V’-shaped mounting member 304 secured or bolted to a front portion of base platform 302. The mounting member includes a substantially cylindrical effector receptacle 305 and a substantially cylindrical mounting receptacle 307 arranged to form the ‘V’-shaped configuration.

Mounting receptacle 307 receives a generally ‘Y’-shaped mounting member 306. Mounting member 306 includes a substantially cylindrical mounting post 315 and a substantially cylindrical support receptacle 311 arranged to form the ‘Y’-shaped configuration. The mounting post includes dimensions less than those of mounting receptacle 307 for insertion within that receptacle, where the mounting post and receptacle form a telescoping arrangement.

Support 103 is substantially similar to the support described above and includes post 104 and support member 106 attached to the top of the post forming a ‘T’-type configuration. The support member includes a curved configuration to contour a user body and pads 107 to enhance user comfort as described above. Post 104 includes dimensions less than those of the support receptacle for insertion within that receptacle, where the post and support receptacle form a telescoping arrangement. Lock mechanisms 308 maintain the positions of mounting post 315 and post 104 to enable adjustment of the support distance and height relative to the user, respectively.

Effector bar 110 is substantially similar to the effector bar described above and includes controller 120. The controller is substantially similar to the controller described above for FIG. 3B and includes handle 122 mounted to the effector bar top surface to enable user interaction with a video game as described above. The effector bar includes dimensions less than those of the effector receptacle for insertion within that receptacle, where the effector bar and receptacle form a telescoping arrangement. Lock mechanism 308 maintains the effector bar position to enable adjustment of the controller height relative to the user.

In addition, the exercise systems described above may further include exercise devices (e.g., foot pedals, stairs, ski type exercisers, treadmills, cycling, etc.) that provide isokinetic and/or isotonic exercise features in addition to the isometric exercise features provided by the effector bar. These exercise devices are associated with signal sources including sensors (e.g., resistors, strain gauges, potentiometers, etc.) that measure user activity and provide a signal indicating the measurement. The exercise devices may be utilized to provide user information to game processor 14 and enable the user to interact with the game in accordance with exercise performed by the user on the devices as described below.

An exemplary control circuit for the system is illustrated in FIG. 4. Specifically, control circuitry 200 includes sensors 150, 160 and corresponding amplifiers 152, 162, exercise processor 154, a switching device or matrix 158 and a signal processor 164. A conventional power supply (not shown) provides appropriate power signals to each of the circuit components. The circuit may be powered by a battery and/or any other suitable power source. A power switch (not shown) may further be included to activate the circuit components.

Sensors 150, 160 are each connected to a respective amplifier 152, 162. The electrical resistance of sensors 150, 160 vary in response to compression and stretching of the effector bar. Amplifiers 152, 162 basically amplify the sensor signals (e.g., in a range compatible with the type of controller employed). The amplified voltage value is sent by each amplifier to exercise processor 154 and switching device 158. Exercise processor 154 may be implemented by any conventional or other processor and typically includes circuitry and/or converts the analog signals from the amplifiers to digital values for processing. Basically, the amplified sensor value represents the force applied by the user, where values toward the range maximum indicate greater applied force. The amplified analog value is digitized or quantized within a range in accordance with the quantity of bits within the converted digital value (e.g., −127 to +127 for eight bits signed, −32,767 to +32,767 for sixteen bits signed, etc.) to indicate the magnitude and/or direction of the applied force. Thus, amplified voltage values toward the range maximum produce digital values toward the maximum values of the quantization ranges.

The exercise processor receives resistance level and reset controls from the user via input devices 156 as described above, and controls amplifier gain parameters to adjust system resistance in accordance with the user specified controls. In particular, the exercise processor adjusts the gain control of the amplifiers in order to facilitate a resistance level in accordance with user input and/or the video game scenario. The gain control parameter basically controls the amount of gain applied by the amplifier to an amplifier input (or sensor measurement). Since greater amplified values correspond to a greater force, increasing the amplifier gain enables a user to exert less force to achieve a particular amplified force value, thereby effectively lowering the resistance of the system for the user. Conversely, reducing the amplifier gain requires a user to exert greater force to achieve the particular amplified force value, thereby increasing the resistance of the system for the user. The exercise processor further adjusts an amplifier Auto Null parameter to zero or tare the strain gauge sensors.

The exercise processor is further connected to display 124 to facilitate display of certain exercise or other related information as described above. The exercise processor receives the amplified sensor values and determines various information for display to a user (e.g., the degree of force applied to a particular effector bar at any given time, the amount of work performed by the user during a particular exercise session, resistance levels, time or elapsed time, force applied to the various axes (X and Y axes), instantaneous force applied and/or any other exercise or other related information). In addition, the exercise processor resets various parameters (e.g., resistance, time, work, etc.) in accordance with reset controls received from input devices 156.

Switching device 158 receives the signals from amplifiers 152, 162 and is coupled to input devices or switch controls 157, joystick 121 and signal processor 164. Switching device 158 is similar to the switching device described above and enables a user to selectively configure controller 120 for game functions as described below. By way of example only, effector bar 110 (FIGS. 3A-3C) serves as a right controller joystick, while joystick 121 serves as the left controller joystick, where the functions of the joysticks with respect to a game may be selectively assigned by a user as described below. However, the effector bar may serve as any joystick or other input device.

The switching device receives information from amplifiers 152, 162 and is coupled to the inputs of signal processor 164. The switching device basically enables information for controller input devices to be selectively placed on the signal processor inputs corresponding to the desired game functions as described above. In particular, switching device 158 is utilized to selectively exchange game functions between joystick 121 and the effector bar. The switching device includes double pole double throw switches 166, 168 that are respectively associated with X and Y motion axes. By way of example only, switch 166 is associated with an X motion axis (e.g., lateral or right/left forces applied to the effector bar or joystick), while switch 168 is associated with the Y motion axis (e.g., forward/backward forces applied to the effector bar or joystick).

A series of switching device outputs 170, 172 and 174, 176 (e.g., labeled RX, LX, RY and LY, respectively, as viewed in FIG. 4) are respectively associated with switches 166, 168 and are each coupled to specific inputs of signal processor 164. The signal processor inputs are typically mapped to game functions in accordance with the game software executed by game processor 14. Switches 166, 168 basically couple the signals from the desired devices (e.g., effector bar or joystick) to the signal processor inputs corresponding to the desired game functions in accordance with controls from a user entered via input devices or switch controls 157. In particular, switch 166 includes for each corresponding throw switch 180, 182 switch contacts that are coupled to sensor 150 and to the signal source of joystick 121 measuring X axis motion. Throw switch 180 is associated with output 170, while throw switch 182 is associated with output 172. These outputs effectively represent the X axis (e.g., lateral or left/right) motion of controller joysticks. The throw switches are configured in a manner to enable the signal from sensor 150 to be placed on one output and the joystick signal to be placed on the other output in accordance with the user control signals, thereby enabling the user to map the joystick or effector bar to a desired game function.

Similarly, switch 168 includes for each corresponding throw switch 184, 186 switch contacts that are coupled to sensor 160 and to the signal source of joystick 121 measuring Y axis motion. Throw switch 184 is associated with output 174, while throw switch 186 is associated with output 176. These outputs effectively represent the Y axis (e.g., forward/backward) motion of controller joysticks. The throw switches are configured in a manner to enable the signal from sensor 160 to be placed on one output and the joystick signal to be placed on the other output in accordance with the user control signals, thereby enabling the user to map the joystick or effector bar to a desired game function. Thus, the functions of joysticks within a game may be selectively assigned to be performed by joystick 121 and/or the effector bar.

Applications of higher complexity with respect to blending functions may require additional selector switches and various combinations of selector switch settings. For example, the joystick or effector bar may individually perform the functions of two joysticks in accordance with the connections. Further, the exercise systems may include various devices (e.g., foot pedals, stairs, ski type exercisers, treadmills, cycling, etc.) that provide isokinetic and/or isotonic exercise features in addition to the isometric exercise features provided by the effector bar as described above. These exercise devices may similarly be assigned to game functions by the user in substantially the same manner described above. In this case, the signal sources associated with these devices are coupled to switching device 158 to direct the signals associated with the exercise devices to the appropriate inputs of signal processor 164. Switching device 158 may include any desired configuration as described above to accomplish the function assignments for these exercise devices.

The signals from the switching device outputs are transmitted to a respective predetermined memory location within signal processor 164. The signal processor may be implemented by any conventional or other processor and typically includes circuitry and/or converts the analog signals from the switching device to digital values for processing in substantially the same manner described above. The signal processor samples the memory locations at predetermined time intervals (e.g., preferably on the order of ten milliseconds or less) to continuously process and send information to the game processor to update and/or respond to an executing gaming application.

Basically, the signal processor processes and arranges the switching device signals into suitable data packets for transmission to the game processor. The signal processor may process raw digital values in any fashion to account for various calibrations or to properly adjust the values within quantization ranges. The data packets are in a format resembling data input from a standard peripheral device (e.g., game controller, etc.). For example, the processor may construct a data packet that includes the status of all controller input devices (e.g., joystick 121, buttons 123, etc.) and the values of each sensor. By way of example only, the data packet may include header information, X-axis information indicating a corresponding sensor force and joystick measurement along this axis, Y-axis information indicating a corresponding sensor force and joystick measurement along this axis, rudder or steering information, throttle or rate information and additional information relating to the status of input devices (e.g., buttons, etc.). Additional packet locations may be associated with data received from controller or other input and/or exercise devices coupled to the signal processor, where the input devices may represent additional operational criteria for the scenario (e.g., the firing of a weapon in the scenario when the user presses an input button, throttle, etc.). The game processor processes the information or data packets in substantially the same manner as that for information received from a conventional peripheral (e.g., game controller, etc.) to update and/or respond to an executing gaming application (e.g., game, etc.).

Operation of exercise systems 100 is described with reference to FIGS. 3A-3C and 4. Initially, the user couples the system to game processor 14 and selectively assigns game functions to the joystick, effector bar and/or other input and/or exercise devices as described above. The user may adjust the exercise system (e.g., controller height, support height and distance, etc.) to accommodate the user physical characteristics. A game is selected and executed on the game processor and the user engages in an exercise to interact with the game. The user operates the system with the user lower body portion (e.g., buttocks) supported by support 103, the user feet engaging grips 105 (FIG. 3A), platform 112 (FIG. 3B) or base platform 302 (FIG. 3C), and the user hands placed on controller handle 122. The user grips the controller handle and applies a force to the controller to exert a strain on the effector bar. The user applies one or more forces to the controller and, hence, the effector bar with respect to at least one of the X and Y axes so as to effect corresponding movement, for example, of a character or an object in the scenario displayed by the game processor. The user may further manipulate joystick 121, other controller input devices and/or other exercise devices for additional actions depending upon the particular game and user function assignments.

The signals from the strain gauge sensors and input and/or exercise devices (e.g., joystick, buttons, stair climbing, cycling, pedals, etc.) are transmitted to signal processor 164 via switching device 158 as described above. The signal processor generates the data packets for transference to game processor 14. The game processor processes the information or data packets in substantially the same manner as that for information received from a conventional peripheral (e.g., game controller, etc.) to update and/or respond to an executing gaming application. Thus, the force applied by the user to the effector bar results in a corresponding coordinate movement or action in the scenario displayed on display 16 in accordance with the function assigned to the bar by the user. In other words, user exercise serves to indicate desired user actions or movements to the game processor to update movement or actions of characters or objects within the game in accordance with the function assigned to the bar or other exercise device by the user. For example, when the user assigns the effector bar accelerator and steering functions, application of a forward force to the controller may serve as the accelerator, while lateral force applied to the controller may serve as the steering function.

It will be appreciated that the embodiments described above and illustrated in the drawings represent only a few of the many ways of implementing a configurable game controller and method of selectively assigning game functions to controller input devices.

The controllers may be of any shape or size, may be constructed of any suitable materials, and may be of the type of any commercially available or other game controller (e.g., those for use with PS2, XBOX, GAMECUBE, etc.). The controllers may include any quantity of any types of input devices (e.g., buttons, slides, joysticks, track type balls, etc.) disposed at any locations and arranged in any fashion. The controllers may include any quantity of any types of signal source devices to generate signals in accordance with input device manipulation (e.g., variable resistors or potentiometers, switches, contacts, relays, sensors, etc.). The signal sources may correspond with any quantity of motion axes for an input device. Any controller input devices may be assigned to any suitable game functions by the switching device.

The switching matrix or devices may be implemented by any quantity of any conventional or other devices capable of switching signals (e.g., switches, multiplexers, cross-bar switch, analog switches, digital switches, routers, logic, gate arrays, logic arrays, etc.). The switching controls or switch control unit may be implemented by any conventional or other control or input devices (e.g., processor, slides, switches, buttons, etc.). The control processor may be implemented by any conventional or other processor or circuitry (e.g., microprocessor, controller, etc.). The switching devices may direct signals from any quantity of inputs to any quantity of outputs in accordance with user-specified or other controls and may map any controller input devices and/or exercise devices to any suitable game functions. The switching device may be disposed internal or external of the controllers.

The game processor may be implemented by any quantity of any personal or other type of computer or processing system (e.g., IBM-compatible, Apple, Macintosh, laptop, palm pilot, microprocessor, gaming consoles such as the Xbox system from Microsoft Corporation, the Play Station 2 system from Sony Corporation, the GameCube system from Nintendo of America, Inc., etc.). The game processor may be a dedicated processor or a general purpose computer system (e.g., personal computer, etc.) with any commercially available operating system (e.g., Windows, Unix, Linux, etc.) and/or commercially available and/or custom software (e.g., communications software, application software, etc.) and any types of input devices (e.g., keyboard, mouse, microphone, etc.). The game processor may execute software from a recorded medium (e.g., hard disk, memory device, CD, DVD or other disks, etc.) or from a network or other connection (e.g., from the Internet or other network).

The exercise systems and components (e.g., frames, effectors, extenders, connectors, bases, base members, supports, grips, platforms, mounting members, posts, receptacles, pads, etc.) may be of any size or shape, may be arranged in any fashion and may be constructed of any suitable materials. The effectors may be constructed of any suitable materials that preferably are subject to measurable deflection within an elastic limit of the materials when subjected to one or more straining or other forces by the user. The effectors may have any suitable geometric configurations, and two or more effectors may be combined in any suitable manner to yield a system frame that conforms to a desired design for a user for a particular application. Any suitable number of any types of sensors (e.g., strain gauges, etc.) may be applied to an effector to facilitate the measurement of any one or more types of strain or other forces applied by the user (e.g., bending forces, twisting forces, compression forces and/or tension forces). Each of the exercise systems may be adjustable in any fashion (e.g., any dimension, controller and/or support height, controller and/or support orientation or distance to the user, etc.) via any types of arrangements of components (e.g., telescoping arrangement, overlapping arrangement, extender components, etc.) to accommodate user physical characteristics. The locking mechanisms may include any type of locking device (e.g., friction device, clamp, peg and hole arrangement, etc.) to releasably maintain an exercise system component in a desired position or orientation to accommodate a user.

Any suitable connector may be utilized to connect any two or more effectors together, including, without limitation, lug nuts, couplings, tee fittings, wye fittings and cross fittings. Any number of connectors may be utilized to form a system frame of effectors. The connectors may be constructed of any suitable materials. The frame may include any quantity of any type of seat or other user support structure disposed at any locations to support a user or user body portions.

Any suitable number of any types of sensors may be disposed at any locations and be utilized to measure any type of strain or other force applied to any suitable number of effectors or to measure any types of user exercise. The sensors may be constructed of any suitable materials, may be disposed at any system locations and may be of any suitable type (e.g., strain gauge, potentiometer, etc.). Further, the sensors may include any electrical, mechanical or chemical properties that vary in a measurable manner in response to applied force or other motion to measure exercise performed by the user. The handle of the exercise system controller may be of any shape or size and disposed at any location to receive force applied by a user. Alternatively, the user may apply force directly to the effector bar. The effector bars and/or exercise devices may be assigned the gaming functions of any desired controller input devices.

The processors (e.g., control, exercise, signal, game, switching devices, etc.) may be implemented by any quantity of any type of microprocessor, processing system or other circuitry, while the control circuitry may be disposed at any suitable locations on the systems, within the controller or, alternatively, remote from the systems. The control circuitry and/or signal processor may be connected to one or more game processors or host computer systems via any suitable peripheral, communications media or other port of those systems. The signal processors may further arrange digital data (e.g., force or other measurements by sensors, controller information, etc.) into any suitable data packet format that is recognizable by the game processor or host computer system receiving data packets from the signal processors. The data packets may be of any desired length, include any desired information and be arranged in any desired format.

The signal processors may sample the information at any desired sampling rate (e.g., seconds, milliseconds, microseconds, etc.), or receive measurement values or other information in response to interrupts. The analog values may be converted to a digital value having any desired quantity of bits or resolution. The processors (e.g., control, signal, exercise, etc.) may process raw digital values in any desired fashion to produce information for transference to the display, game processor or host computer system. This information is typically dependent upon a particular application. The correlation between the measured force or exercise motion and provided value for that force or motion may be determined in any desired fashion. By way of example, the amplified measurement range may be divided into units corresponding to the resolution of the digital value. For an eight bit unsigned digital value (e.g., where the value indicates the magnitude of force), each increment represents 1/256 of the voltage range. With respect to a five volt range, each increment is 5/256 of a volt, which is approximately 0.02 volts. Thus, for an amplified force measurement of three volts, the digital value may correspond to approximately 150 (i.e., 3.0/0.2).

Any suitable number of any types of conventional or other circuitry may be utilized to implement the control circuit, amplifiers, sensors, switching device and processors (e.g., exercise, control, signal, etc.). The amplifiers may produce an amplified value in any desired voltage range, while the A/D conversion may produce a digitized value having any desired resolution or quantity of bits (e.g., signed or unsigned). The control circuit may include any quantity of the above or other components arranged in any fashion. The resistance change of the sensors may be determined in any manner via any suitable conventional or other circuitry. The amplifiers and processors (e.g., exercise, signal, etc.) may be separate within a circuit or integrated as a single unit. Any suitable number of any type of conventional or other displays may be connected to the processors (e.g., exercise, signal, control, game, etc.) to provide any type of information relating to a particular computer interactive exercise session (e.g., results from isometric exercises including force and work, results from motion exercise including speed and distance traveled, calories burned, etc.). A display may be located at any suitable location on or remote from the exercise systems.

Any suitable number of additional input devices may be provided for the system to enhance video game scenarios. The input devices may be provided on any suitable number of control panels that are accessible by the user during system operation and have any suitable configuration (e.g., buttons, switches, keypads, etc.). The exercise devices (e.g., foot pedals, stairs, ski type exercisers, treadmills, etc.) may provide any isokinetic and/or isotonic exercise features in addition to or instead of the isometric exercise features provided by effectors. The exercise devices may be assigned to any desired game functions in the manner described above and may further be resistance controlled by the exercise processor, where control signals may be transmitted to a resistance or braking device or the amount of effort required by the user may be modified.

The resistance level for the effector bar and other exercise devices may be controlled by adjusting amplifier or other parameters. Alternatively, the resistance level may be controlled based on thresholds entered by a user. For example, the processors (e.g., exercise and/or signal processors) may be configured to require a threshold resistance level be achieved, which is proportionate to the amount of straining force applied by the user to one or more effectors or to an amount of motion or force applied to an exercise device (e.g., rate of stair climbing or pedaling, etc.) before assigning appropriate data values to the data packets to be sent to the game processor or host computer. Threshold values for the change in resistance may be input to the processor by the user via an appropriate input device (e.g., a keypad).

It is to be understood that the software of the exercise systems and/or processors (e.g., control, exercise, game, signal, switching devices, etc.) may be implemented in any desired computer language, and could be developed by one of ordinary skill in the computer and/or programming arts based on the functional description contained herein. Further, any references herein of software performing various functions generally refer to computer systems or processors performing those functions under software control. The processors (e.g., control, exercise, signal, switching device, etc.) may alternatively be implemented by hardware or other processing circuitry, or may be implemented on the game processor or host system as software and/or hardware modules receiving the sensor and/or input device information or signals. The various functions of the processors (e.g., control, exercise, signal, game, switching devices, etc.) may be distributed in any manner among any quantity (e.g., one or more) of hardware and/or software modules or units, processors, computer or processing systems or circuitry, where the processors, computer or processing systems or circuitry may be disposed locally or remotely of each other and communicate via any suitable communications medium (e.g., LAN, WAN, Intranet, Internet, hardwire, modem connection, wireless, etc.). The software and/or algorithms described above may be modified in any manner that accomplishes the functions described herein.

The terms “upward”, “downward”, “top”, “bottom”, “side”, “front”, “rear”, “upper”, “lower”, “vertical”, “horizontal”, “height”, “width”, “length”, “forward, “backward”, “left”, “right” and the like are used herein merely to describe points of reference and do not limit the present invention to any specific orientation or configuration.

The present invention controller is not limited to the gaming applications described above, but may be utilized as a configurable peripheral for any processing system, software or application.

From the foregoing description, it will be appreciated that the invention makes available a novel configurable game controller and method of selectively assigning game functions to controller input devices, wherein a controller for a video game system enables a user to selectively assign game functions to controller input devices.

Having described preferred embodiments of a new and improved configurable game controller and method of selectively assigning game functions to controller input devices, it is believed that other modifications, variations and changes will be suggested to those skilled in the art in view of the teachings set forth herein. It is therefore to be understood that all such variations, modifications and changes are believed to fall within the scope of the present invention as defined by the appended claims.

1. A configurable game controller to interact with a game processor including a gaming application comprising:
a plurality of user-manipulable input devices;
a plurality of signal sources each to detect manipulation of a corresponding input device and to generate a manipulation signal indicating said measured manipulation to enable control of a corresponding gaming application function; and
a configuration module to assign said gaming application functions to said input devices in accordance with device function assignments received from a user.

2. The game controller of claim 1, wherein said input devices include at least one of joysticks, buttons and switches.

3. The game controller of claim 1 further including:
a signal processor to receive and process said manipulation signals and transfer information to said game processor in a format compatible with said game processor to control said gaming application functions, wherein said signal processor includes a plurality of inputs each associated with a corresponding gaming application function and receiving a manipulation signal from a corresponding input device.

4. The game controller of claim 3, wherein said configuration module includes:
a switching device coupled to said signal sources and said signal processor to direct said manipulation signals from said signal sources to signal processor inputs in accordance with said device function assignments from said user to assign said input devices to said gaming application functions.

5. The game controller of claim 4 further including:
a switch control unit to enable entry of said device function assignments from said user and to control said switching device to direct said manipulation signals from said signal sources to signal processor inputs in accordance with said device function assignments.

6. The game controller of claim 4, wherein said switching device includes at least one double pole double throw switch.

7. The game controller of claim 4, wherein said configuration module further includes a user interface to enable entry of said device function assignments and to control said switching device to direct said manipulation signals from said signal sources to signal processor inputs in accordance with said device function assignments.

8. The game controller of claim 1, wherein said game controller is disposed within an exercise system, and wherein said configuration module assigns at least one of said gaming application functions to said exercise system in accordance with said device function assignments from said user to enable user exercise to control at least one gaming application function.

9. The game controller of claim 8, wherein said exercise system includes an effector bar to provide isometric exercise for a user, and wherein said configuration module assigns at least one of said gaming application functions to said effector bar in accordance with said device function assignments from said user to enable user isometric exercise to control at least one gaming application function.

10. A method of configuring a game controller to interact with a game processor including a gaming application, wherein said game controller includes a plurality of user-manipulable input devices and a plurality of signal sources each associated with a corresponding input device to detect manipulation of that device, said method comprising:
(a) receiving device function assignments from a user;
(b) assigning said gaming application functions to said input devices in accordance with said device function assignments; and
(c) detecting manipulation of an input device and generating a manipulation signal indicating said measured manipulation to enable control of a corresponding gaming application function.

11. The method of claim 10, wherein said input devices include at least one of joysticks, buttons and switches.

12. The method of claim 10, wherein said game controller further includes a signal processor with a plurality of inputs each associated with a corresponding gaming application function and receiving a manipulation signal from a corresponding input device, and step (c) further includes:
(c.1) receiving and processing said manipulation signals and transferring information to said game processor in a format compatible with said game processor to control said gaming application functions.

13. The method of claim 12, wherein step (c.1) further includes:
(c.1.1) directing said manipulation signals to signal processor inputs, via a switching device, in accordance with said device function assignments from said user to assign said input devices to said gaming application functions.

14. The method of claim 13, wherein step (a) further includes:
(a.1) receiving said device function assignments from said user via a switch control unit; and
step (b) further includes:
(b.1) controlling said switching device to direct said manipulation signals to signal processor inputs in accordance with said device function assignments.

15. The method of claim 13, wherein step (a) further includes:
(a.1) receiving said device function assignments from said user via a user interface; and
step (b) further includes:
(b.1) controlling said switching device to direct said manipulation signals to signal processor inputs in accordance with said device function assignments.

16. The method of claim 10, wherein said game controller is disposed within an exercise system, and step (b) further includes:
(b.1) assigning at least one of said gaming application functions to said exercise system in accordance with said device function assignments from said user to enable user exercise to control at least one gaming application function.

17. The method of claim 16, wherein said exercise system includes an effector bar to provide isometric exercise for a user, and step (b.1) further includes:
(b.1.1) assigning at least one of said gaming application functions to said effector bar in accordance with said device function assignments from said user to enable user isometric exercise to control at least one gaming application function.

18. An exercise system serving as a peripheral to facilitate user interaction with a processor including an application comprising:
at least one exercise device providing an exercise for a user;
at least one sensor to measure exercise performed by said user;
a controller including:
a plurality of user-manipulable input devices;
a plurality of signal sources each to detect manipulation of a corresponding input device and to generate a manipulation signal indicating said measured manipulation to enable control of a corresponding application function; and
a configuration module to assign said application functions to at least one of said input devices and said at least one exercise device in accordance with device function assignments received from a user; and
a signal processor to receive and process data corresponding to exercise information measured by said at least one sensor and said manipulation signals from said signal sources for transference to said processor, wherein said signal processor facilitates user interaction with said processor in response to manipulation of at least one of said input devices and said at least one exercise device by said user.

19. The exercise system of claim 18, wherein said input devices include at least one of joysticks, buttons and switches.

20. The exercise system of claim 18, wherein said signal processor includes a plurality of inputs each associated with a corresponding application function, and said configuration module includes:
a switching device coupled to said signal sources, said at least one sensor and said signal processor to direct said manipulation signals and said exercise information to signal processor inputs in accordance with said device function assignments from said user to assign said input devices and said at least one exercise device to said application functions.

21. The exercise system of claim 20, wherein said controller further includes:
a switch control unit to enable entry of said device function assignments from said user and to control said switching device to direct said manipulation signals and said exercise information to signal processor inputs in accordance with said device function assignments.

22. The exercise system of claim 20, wherein said switching device includes at least one double pole double throw switch.

23. The exercise system of claim 18, wherein said controller further includes:
an exercise processor to receive and process data corresponding to exercise information measured by said at least one sensor.

24. The exercise system of claim 23, wherein said at least one exercise device includes at least one effector providing an isometric exercise for said user and said at least one sensor includes at least one force sensor coupled at a selected location on said at least one effector to measure at least one force applied by said user to said at least one effector, and wherein said at least one applied force effects a measurable strain on said at least one effector.

25. The exercise system of claim 23, wherein said controller further includes:
a display controlled by said exercise processor to output information relating to exercise performed by said user.

26. The exercise system of claim 24, wherein said exercise processor further determines an amount of work applied by said user for a selected period of time and controls a display to output information relating to the amount of work applied by said user.

27. The exercise system of claim 23, wherein said exercise processor further selectively adjusts an amount of exercise that must be performed by said user to facilitate user interaction with said application.

28. The exercise system of claim 27, wherein said controller further includes:
an exercise input device to input to said exercise processor the amount of exercise that must be performed by said user.

29. The exercise system of claim 24, wherein said controller is disposed on at least one effector and includes a handle to receive at least one force applied by said user.

30. The exercise system of claim 18, wherein said processor is a game processor including a gaming application.

31. A method of performing an exercise utilizing a system that serves as a peripheral to facilitate user interaction with a processor including an application, said system including: at least one exercise device, at least one sensor, and a controller including a plurality of user-manipulable input devices, a plurality of signal sources each to detect manipulation of a corresponding input device, and a signal processor, the method comprising:
(a) receiving device function assignments from a user;
(b) assigning application functions to at least one of said input devices and said at least one exercise device in accordance with said device function assignments;
(c) detecting manipulation of an input device and generating a manipulation signal indicating said measured manipulation;
(d) measuring exercise performed by a user via said at least one sensor; and
(e) processing data corresponding to exercise information measured by said at least one sensor and said manipulation signals for transference to said processor, wherein user interaction with said processor is facilitated in response to manipulation of at least one of said input devices and said at least one exercise device by said user.

32. The method of claim 31, wherein said input devices include at least one of joysticks, buttons and switches.

33. The method of claim 31, wherein said signal processor includes a plurality of inputs each associated with a corresponding application function, and step (e) further includes:
(e.1) directing said manipulation signals and said exercise information to signal processor inputs, via a switching device, in accordance with said device function assignments from said user to assign said input devices and said at least one exercise device to said application functions.

34. The method of claim 33, wherein step (a) further includes:
(a.1) receiving said device function assignments from said user via a switch control unit; and
step (b) further includes:
(b.1) controlling said switching device to direct said manipulation signals and said exercise information to signal processor inputs in accordance with said device function assignments.

35. The method of claim 31, wherein said controller further includes an exercise processor, and step (e) further includes:
(e.1) processing data corresponding to exercise information measured by said at least one sensor to produce information relating to user exercise.

36. The method of claim 35, wherein said at least one exercise device includes at least one effector and said at least one sensor includes at least one force sensor coupled at a selected location on said at least one effector, and step (b) further includes:
(b.1) assigning application functions to at least one of said input devices and said at least one effector in accordance with said device function assignments; and
step (d) further includes:
(d.1) measuring at least one force applied by said user to said at least one effector with said at least one force sensor, wherein said at least one effector provides an isometric exercise for said user and said applied force effects a measurable strain on said at least one effector.

37. The method of claim 35, wherein said controller further includes a display, and step (e) further includes:
(e.2) displaying information relating to exercise performed by said user on said display.

38. The method of claim 36, wherein step (e.1) further includes:
(e.1.1) determining an amount of work applied by said user for a selected period of time and controlling a display to output information relating to the amount of work applied by said user.

39. The method of claim 35, wherein step (e) further includes:
(e.2) selectively adjusting an amount of exercise that must be performed by said user to facilitate user interaction with said application.

40. The method of claim 39, wherein step (e.2) further includes:
(e.2.1) receiving from said user the amount of exercise that must be performed by said user.

41. The method of claim 31, wherein said processor is a game processor including a gaming application.
